(19) United States
(12) Patent Application Publication
(10) Pub. No.: US 2023/0230014 A1
(43) Pub. Date: Jul. 20, 2023

(54) SYSTEM AND METHOD FOR DETERMINING AN AGENT PROFICIENCY WHEN ADDRESSING CONCURRENT CUSTOMER SESSIONS AND UTILIZATION THEREOF

(71) Applicant: NICE LTD., Ra'anana (IL)

(72) Inventors: Kunal Khanvilkar, Pune (IN); Rahul Vyas, Jodhpur (IN); Salil Dhawan, Pune (IN); Sourav Chauhan, New Delhi (IN)

(21) Appl. No.: 17/576,952

(22) Filed: Jan. 16, 2022

(51) Int. Cl. G06Q 10/06; H04M 3/51; H04M 3/523

(52) U.S. Cl. CPC G06Q 10/06398; G06Q 10/06395; H04M 3/5175; H04M 3/5237; H04M 2203/402; H04M 2203/403

(57) ABSTRACT

A computerized-method for determining an agent-proficiency when addressing concurrent customer sessions via one or more channel types and utilization thereof is provided herein. The computerized-method includes operating a Concurrent-Sessions-Handling-Agent-Proficiency (CSHAP) module. The CSHAP-module includes: (a) operating an interactions-module to retrieve one or more interactions and metadata thereof of the agent; (b) for each interaction, determining if the interaction has been handled with concurrent interactions; (c) for each determined interaction as handled with concurrent interactions, checking in the metadata if the interaction has one or more defocused-events; (d) calculating a CSHAP-score for the agent based on one or more attributes from the metadata of the interaction to provide an indication as to an ability of the agent to address concurrent customer sessions; (e) storing the calculated CSHAP-score in a data-store; and (f) sending the CSHAP-score to one or more applications, to take one or more follow-up actions based on the CSHAP-score.

### TECHNICAL FIELD

The present disclosure relates to the field of data analyzing and more specifically to determining an agent proficiency when addressing concurrent customer sessions via one or more channel types.

### BACKGROUND

In today's contact centers, agents can serve several customers simultaneously via one or more channel types. The ability for each agent to handle customer interactions concurrently on the same or on different channel types, substantially increases contact center performance by improving agent productivity and utilization.

However, handling too many concurrent customer sessions by an agent may cause overload and rushed responses. Moreover, concurrent customer sessions may influence response time, customer satisfaction and even agent morale. Therefore, it may be significant to make sure that these concurrent customer sessions aren't mismanaged.

Current available solutions consider only the overall handling time of an interaction to calculate agent effectiveness. However, there is no technical solution which determines agent proficiency of addressing concurrent customer sessions that is taking into consideration inactive-time of the agent and customer during the interaction, e.g., defocused event, or active-time of the agent or the customer during the interaction, e.g., focus event.

Accordingly, there is a need for a technical solution for a system and method for determining an agent proficiency when addressing concurrent customer sessions via one or more channel types, by considering inactive-time of an agent and a customer during an interaction.

### SUMMARY

There is thus provided, in accordance with some embodiments of the present disclosure, a computerized-method for determining an agent proficiency when addressing concurrent customer sessions via one or more channel types and utilization thereof.

Furthermore, in accordance with some embodiments of the present disclosure, in a computerized system that may include one or more processors, a data store of interactions, a data store of agents; and a memory to store the data stores, the one or more processors may operate for each agent in the data store of agents, a Concurrent Sessions Handling Agent Proficiency (CSHAP) module.

Furthermore, in accordance with some embodiments of the present disclosure, the CSHAP module may include: (a) operating an interactions module to retrieve one or more interactions and metadata thereof of the agent from the data store of interactions, during a preconfigured period; (b) for each interaction of the one or more retrieved interactions, determining if the interaction has been handled with concurrent different interactions during the preconfigured period, via one or more channel types; (c) for each determined interaction as handled with concurrent different interactions, checking in the metadata if the interaction has one or more defocused events. Defocused events are inactive-time events of an agent and a customer during the interaction and focused events are active-time events of the agent and the customer; (d) calculating a CSHAP score for the agent based on one or more attributes from the metadata of the interaction to provide an indication as to an ability of the agent to address different concurrent customer sessions via one or more channel types; (e) storing the calculated CSHAP score in the data store of agents; and (f) sending the CSHAP score to one or more applications, to take one or more follow-up actions based on the CSHAP score.

Furthermore, in accordance with some embodiments of the present disclosure, the CSHAP module may operate every preconfigured duty cycle.

Furthermore, in accordance with some embodiments of the present disclosure, the calculating of the CSHAP score for the agent may be based on formula (I):

$$Concurrent Sessions Handling Agent Proficiency ( CSHAP ) score = {\sum }_{i = 1}^{N} ( \frac{CSi * FTi}{T i} ) * W effective \qquad ( 1 )$$

whereby:

N is a total number of concurrent different interactions handled by an agent during the preconfigured period,

CSi is a Customer Sentiment or feedback score for an interaction,

Ti is a total time taken to handle an interaction,

FTi is a total time of one or more focused events during an interaction, and

W_{effective} is an effective weighting factor of concurrent channel requests based on formula II:

Πᵢ₌₁^{N}Wi (II)

whereby:

Wi is a weighting factor of each channel type, and

N is a total number of concurrent different interactions handled by an agent during the preconfigured period.

Furthermore, in accordance with some embodiments of the present disclosure, one application of the one or more applications may be a gamification application. The one or more follow-up actions of the gamification application based on the CSHAP score, may provide at least one reward or recognition to the agent.

Furthermore, in accordance with some embodiments of the present disclosure, the at least one reward or recognition to the agent may be provided to the agent, when the CSHAP score is above a predefined threshold or between a predefined range.

Furthermore, in accordance with some embodiments of the present disclosure, one application of the one or more applications may be a Quality Management (QM) application. The one or more follow-up actions of the QM application, based on the CSHAP score, may be assigning a coaching program by an evaluator when the CSHAP score is below a predefined threshold.

Furthermore, in accordance with some embodiments of the present disclosure, one application of the one or more applications may be an Automated Call Distribution (ACD) system. The one or more follow-up actions of the ACD system, based on the CSHAP score, may include changing attributes of routing skills of the agent.

Furthermore, in accordance with some embodiments of the present disclosure, when the computerized-method is operating in a cloud computing environment, before operating the CSHAP module the computerized-method may further comprise selecting a tenant from a data store of tenants to operate the CSHAP module for each agent in the data store of agents of the selected tenant.

There is further provided, in accordance with some embodiments of the present disclosure, a computerized-system for determining an agent proficiency when addressing concurrent customer sessions, via one or more channel types.

Furthermore, in accordance with some embodiments of the present disclosure, the computerized-system may include: one or more processors, a data store of interactions; a data store of agents; and a memory to store the data stores. The one or more processors may be configured to operate for each agent in the data store of agents, a Concurrent Sessions Handling Agent Proficiency (CSHAP) module as described above.

### BRIEF DESCRIPTION OF THE DRAWINGS

FIGS. 1A-1B schematically illustrate a high-level diagram of a system for determining an agent proficiency when addressing concurrent customer sessions via one or more channel types by considering inactive-time of an agent and a customer during an interaction and utilization thereof, in accordance with some embodiments of the present disclosure;

FIGS. 2A-2B are a high-level workflow of a Concurrent Sessions Handling Agent Proficiency (CSHAP) module, in accordance with some embodiments of the present disclosure;

FIG. 3 is a graphic representation of concurrent customer sessions addressed by an agent via a plurality of channel types where each session includes inactive-time of the agent and a customer during an interaction, in accordance with some embodiments of the present disclosure;

FIG. 4 schematically illustrates components of an example of a CSHAP module determining agent proficiency when addressing concurrent customer sessions via one or more channel types and utilization thereof by a gamitication application, in accordance with some embodiments of the present disclosure; and

FIG. 5 schematically illustrates components of an example of a CSHAP module determining agent proficiency when addressing concurrent customer sessions via one or more channel types by considering inactive-time of an agent and a customer during an interaction and utilization thereof by a Quality Management (QM) application, in accordance with some embodiments of the present disclosure.

### DETAILED DESCRIPTION

In the following detailed description, numerous specific details arc set forth in order to provide a thorough understanding of the disclosure. However, it will be understood by those of ordinary skill in the art that the disclosure may be practiced without these specific details. In other instances, well-known methods, procedures, components, modules, units and/or circuits have not been described in detail so as not to obscure the disclosure.

Although embodiments of the disclosure are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium (e.g., a memory) that may store instructions to perform operations and/or processes.

Although embodiments of the disclosure are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. Unless explicitly stated, the method embodiments described herein are not constrained to a particular order or sequence. Additionally, some of the described method embodiments or elements thereof can occur or be performed simultaneously, at the same point in time, or concurrently. Unless otherwise indicated, use of the conjunction “or” as used herein is to be understood as inclusive (any or all of the stated options).

Nowadays, customers expect to connect with an agent for query resolution, in every possible channel type, e.g., voice channel and digital channel. When an agent can address customer issues and concerns quickly, it creates better customer experiences and increases customer. Also, addressing concurrent customer sessions effectively may be a competitive advantage, which provides a unique customer experience, and may increase the amount of interactions per period of time.

The addressing of concurrent customer sessions may substantially increase contact center performance by improving agent productivity and utilization, as agents can serve concurrent customers effectively. Contact centers who provide seamless customer experience achieve a 91% higher year-over-year increase in customer retention, compared to organizations who don't provide.

Too few concurrent customer sessions addressed by an agent than the agent can handle, may result in a long customer queue and increased wait time. Whereas enabling, e.g., routing, too many concurrent customer sessions than the agent can handle may cause an overload and rushed responses which may result with customers dissatisfaction and agents' burnout.

Current technical solutions merely consider the overall handling time of an interaction to calculate agent effectiveness of addressing concurrent customer sessions via one or more channel types. However, there is no technical solution which determines agent proficiency of addressing concurrent customer sessions by considering focus and defocused events of an interaction and utilization thereof.

Therefore, there is a need for method and system for determining an agent proficiency when addressing concurrent customer sessions via one or more channel types and utilization thereof

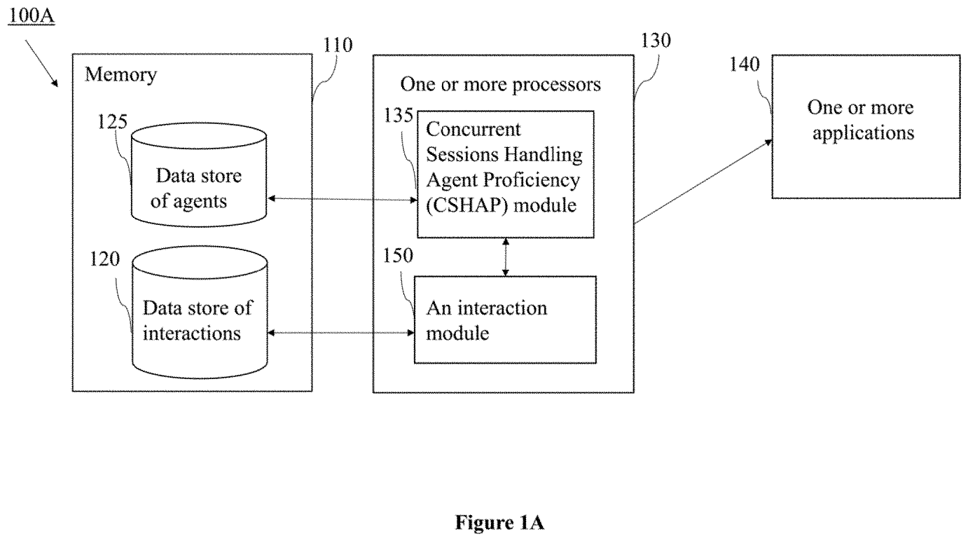

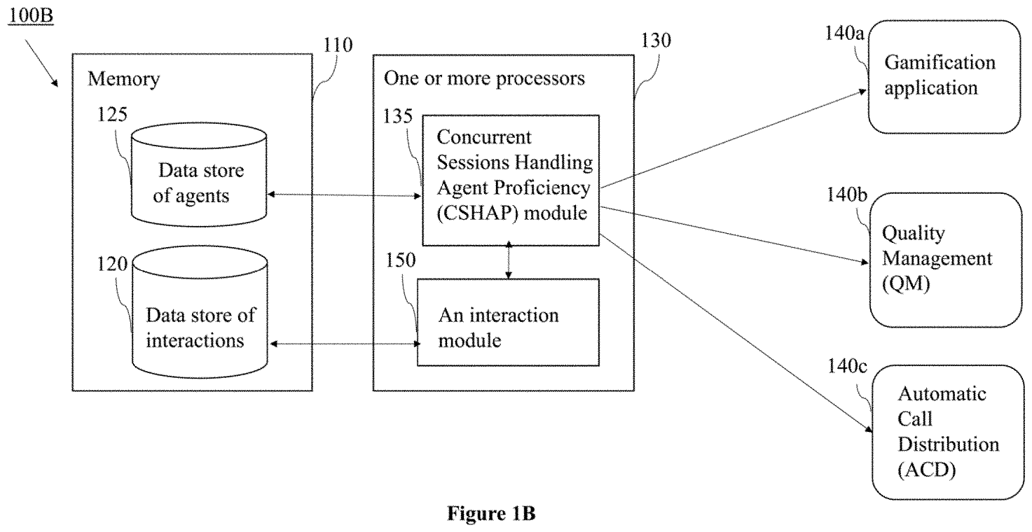

FIG. 1A schematically illustrates a high-level diagram of a system 100A for determining an agent proficiency when addressing concurrent customer sessions via one or more channel types by considering inactive-time of an agent and a customer during an interaction and utilization thereof, in accordance with some embodiments of the present disclosure.

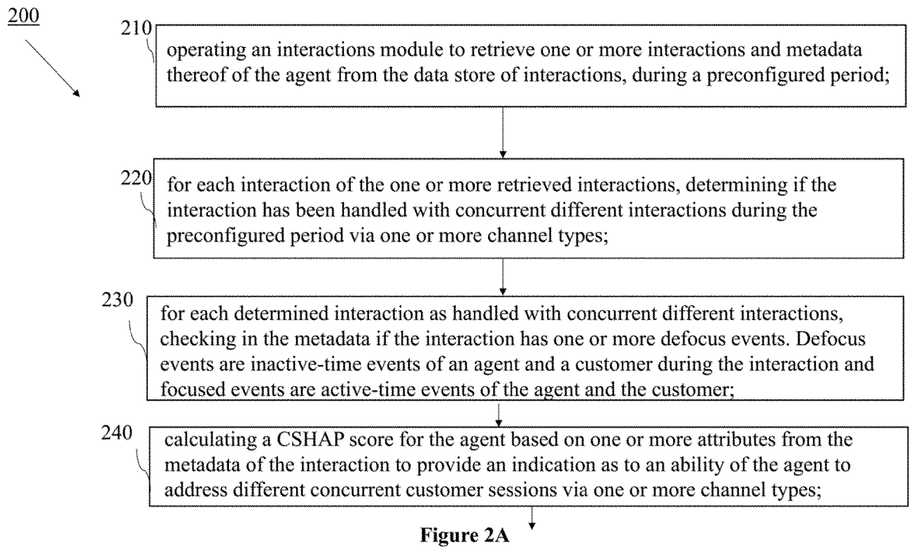

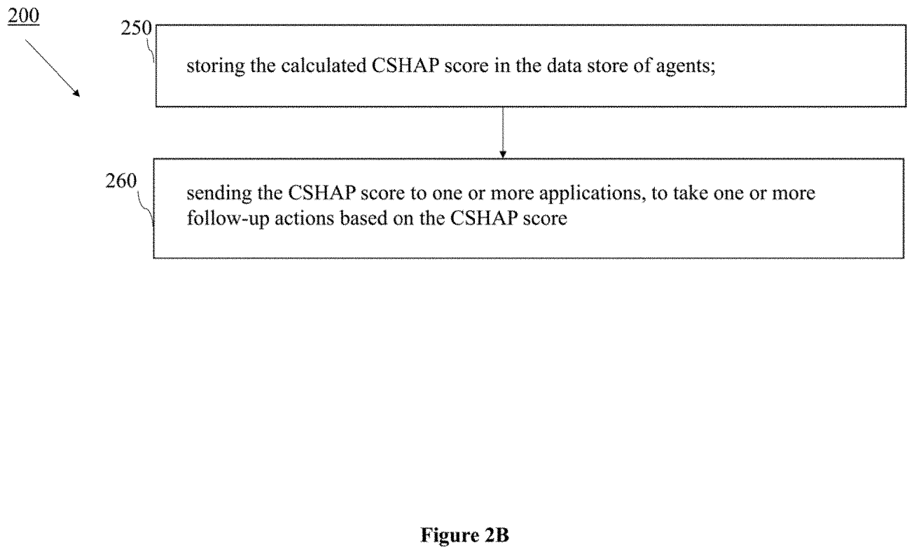

According to some embodiments of the present disclosure, a computerized system, such as system 100A may include one or more processors 130, a data store, such as data store of interactions 120, a data store such as data store of agents 125; and a memory 110 to store the data stores. The one or more processors 130 may operate for each agent in the data store of agents 125, a module, such as Concurrent Sessions Handling Agent Proficiency (CSHAP) module 135, and such as module CSHAP 200 in FIGS. 2A-2B.

According to some embodiments of the present disclosure, the CSHAP module 135 may calculate a CSHAP score for each agent in the data store of agents and then store the CSHAP score of the agent in a data store, such as data store of agents 125 and then send the CSHAP score of the agent to one or more applications 140 for utilization thereof, e.g., to take one or more follow-up actions based on the CSHAP score of the agent.

According to some embodiments of the present disclosure, for the calculation operation of the CSHAP score, the CSHAP module 135 may initially operate a module, such as an interactions module 150 to retrieve one or more interactions and metadata thereof of the agent from the data store of interactions 120, during a preconfigured period.

According to some embodiments of the present disclosure, for each interaction of the one or more retrieved interactions, the CSHAP module 135 may determine if the interaction has been handled with concurrent different interactions during the preconfigured period, via one or more channel types.

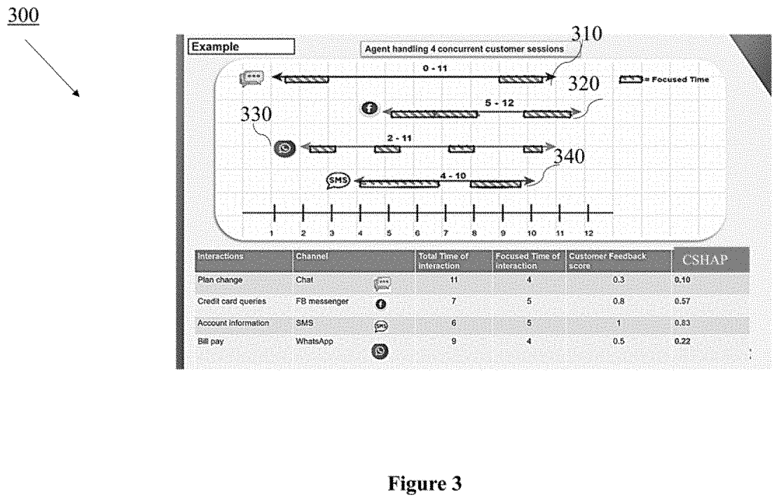

According to some embodiments of the present disclosure, for each determined interaction as handled with concurrent different interactions, the CSHAP module 135 may check in the metadata if the interaction has one or more defocused events. The defocused events are inactive-time events of an agent and a customer during the interaction and focused events are active-time events of the agent and the customer as presented in the graphic representation 300 in FIG. 3, of concurrent customer sessions, addressed by an agent, via a plurality of channel types where each session includes inactive-time of the agent and a customer during an interaction.

According to some embodiments of the present disclosure, based on one or more attributes from the metadata of each interaction from the interactions that have been handled with concurrent different interactions and has one or more defocused events, the CSHAP module 135 may calculate a CSHAP score for the agent to provide an indication as to an ability of the agent to address different concurrent customer sessions via one or more channel types at the same time. A high CSHAP score may be an indication as to an agent handling concurrent customer sessions more efficiently and effectively.

According to some embodiments of the present disclosure, the one or more follow-up actions based on the CSHAP score, by the one or more application may improve the process of evaluation and performance of agents in the contact center. The improvement of the process of evaluation and performance may further increase the efficiency of the contact center by an improved agents' productivity and utilization rates and as a result may also elevate customers satisfaction.

In other words, the calculated CSHAP score may indicate that the agent is more efficient in handling cost per channel utilized, so, it may also improve key contact center Key Performance Indicators (KPI)s.

According to some embodiments of the present disclosure, the CSHAP module may operate every preconfigured duty cycle, e.g. every preconfigured period of time.

According to some embodiments of the present disclosure, the calculating of the CSHAP score for the agent may be based on formula (I):

$$Concurrent Sessions Handling Agent Proficiency ( CSHAP ) score = {\sum }_{i = 1}^{N} ( \frac{CSi + FTi}{T i} ) * W effective \qquad ( 1 )$$

whereby:

N is a total number of concurrent different interactions handled by an agent during the preconfigured period,

CSi is Customer Sentiment or feedback score for an interaction,

Ti is total time taken to handle an interaction,

FTi is total time of one or more focused events during an interaction,

W_{effective} is an effective weighting factor of concurrent channel requests based on formula II:

Πᵢ₌₁^{N}Wi (II)

whereby:

Wi is a weighting factor of each channel type, and

N is a total number of concurrent different interactions handled by an agent during the preconfigured period.

According to some embodiments of the present disclosure, Wi may be a weighting factor of each channel type and N may be a total number of interactions handled concurrently by the agent. Optionally, the precedence of weighting factor may be assigned as w1>w2>w3, i.e. (audio>chat>email) because practically interactions are handled primarily via audio then chat then email. High weighted factor channels may have a higher impact on the CSHAP score.

According to some embodiments of the present disclosure, the CSHAP score may be directly proportional to the total focused time of concurrent customer sessions handled by the agent.

According to some embodiments of the present disclosure, one application of the one or more applications may be a gamification application, a Quality Management (QM) application or an Automated Call Distribution (ACD) system, as shown in FIG. 1B.

According to some embodiments of the present disclosure, when system 100A is operating in a cloud computing environment, before operating the CSHAP module 135 the system 100A may further comprise selecting a tenant from a data store of tenants to operate the CSHAP module 135 for each agent in the data store of agents of the selected tenant.

According to some embodiments of the present disclosure,

FIG. 1B schematically illustrates a high-level diagram of a system 100B for determining an agent proficiency when addressing concurrent customer sessions via one or more channel types by considering inactive-time of an agent and a customer during an interaction and utilization thereof, in accordance with some embodiments of the present disclosure.

According to some embodiments of the present disclosure, a computerized system, such as system 100B may include all the components of system 100A, which are one or more processors 130, a data store, such as data store of interactions 120, a data store such as data store of agents 125; and a memory 110 to store the data stores. The one or more processors 130 may operate for each agent in the data store of agents 125, a module, such as Concurrent Sessions Handling Agent Proficiency (CSHAP) module 135, and such as module CSHAP 200, in FIGS. 2A-2B.

According to some embodiments of the present disclosure, the CSHAP module 135 may calculate a CSHAP score for each agent in the data store of agents and then store the CSHAP score of the agent in a data store, such as data store of agents 125 and then send the CSHAP score of the agent to one or more applications 140a-140c for utilization thereof, e.g., to take one or more follow-up actions based on the CSHAP score of the agent.

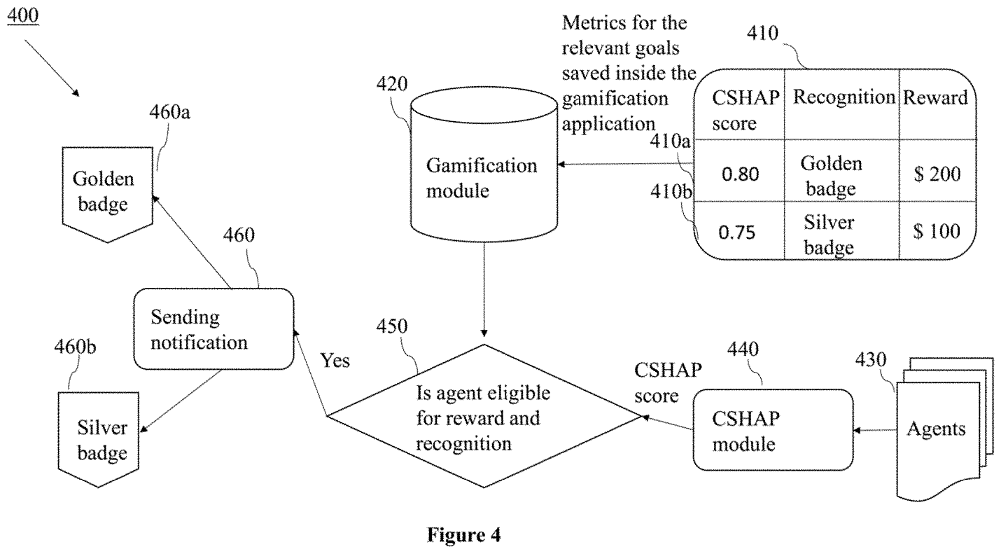

According to some embodiments of the present disclosure, the at least one reward or recognition to the agent may be provided to the agent, when the CSHAP score is above a predefined threshold or between a predefined range as shown in example 400 in FIG. 4.

According to some embodiments of the present disclosure, the one application of the one or more applications may be a gamification application 140a. The one or more follow-up actions of the gamification application 140a based on the CSHAP score, may be providing at least one reward or recognition to the agent, as described in detail below as to example 400 in FIG. 4 of a CSHAP module determining agent proficiency when addressing concurrent customer sessions via one or more channel types by considering inactive-time of an agent and a customer during an interaction and utilization thereof by a gamification application. Thus, motivating employees to perform more efficiently and also enabling an organization to align such significant goals of agents' performance with those of the business itself.

According to some embodiments of the present disclosure, one application of the one or more applications may be a Quality Management (QM) application 140b.

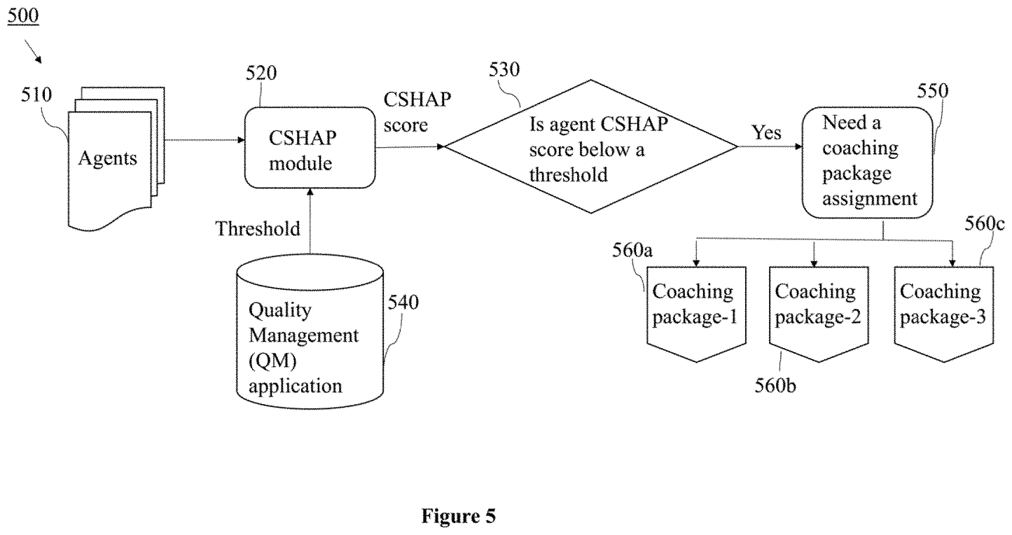

According to some embodiments of the present disclosure, the one or more follow-up actions of the QM application 140b, based on the CSHAP score may be assigning a coaching package or program by an evaluator, when the CSHAP score is below a predefined threshold, as shown in example 500 in FIG. 5.

According to some embodiments of the present disclosure, one application of the one or more applications may be an Automated Call Distribution (ACD) system 140c.

According to some embodiments of the present disclosure, the one or more follow-up actions of the ACD system 140c based on the CSHAP score, may include changing attributes of routing skills of the agent.

For example, if the agent can address concurrent customer sessions, via one or more channel types effectively and efficiently, i.e., high CSHAP score, then the attributes of the routing skills of the agent can be elevated, e.g., changed from beginner to expert. Alternatively, when the CSHAP score is poor, the routing skills of the agent may be downgraded, e.g., changed from expert to beginner.

FIGS. 2A-2B are a high-level workflow of a Concurrent Sessions Handling Agent Proficiency (CSHAP) module, in accordance with some embodiments of the present disclosure.

According to some embodiments of the present disclosure, operation 210 may comprise operating an interactions module to retrieve one or more interactions and metadata thereof of the agent from the data store of interactions, during a preconfigured period. The interactions module may be a module, such as interactions module 150 in FIGS. 1A-1B.

According to some embodiments of the present disclosure, operation 220 may comprise for each interaction of the one or more retrieved interactions, determining if the interaction has been handled with concurrent different interactions during the preconfigured period via one or more channel types.

According to some embodiments of the present disclosure, operation 230 may comprise for each determined interaction as handled with concurrent different interactions, checking in the metadata if the interaction has one or more defocused events. Defocused events are inactive-time events of an agent and a customer during the interaction and focused events are active-time events of the agent and the customer.

According to some embodiments of the present disclosure, operation 240 may comprise calculating a CSHAP score for the agent based on one or more attributes from the metadata of the interaction to provide an indication as to an ability of the agent to address different concurrent customer sessions via one or more channel types.

According to some embodiments of the present disclosure, operation 250 may comprise storing the calculated CSHAP score in the data store of agents.

According to some embodiments of the present disclosure, operation 260 may comprise sending the CSHAP score to one or more applications, to take one or more follow-up actions based on the CSHAP score.

FIG. 3 is a graphic representation 300 of concurrent customer sessions addressed by an agent via a plurality of channel types where each session includes inactive-time of the agent and a customer during an interaction, in accordance with some embodiments of the present disclosure.

According to some embodiments of the present disclosure, four concurrent sessions may be handled by an agent via a plurality of channel types such as chat 310, Facebook-chat 230, Whatsapp-messenger 330 and Short Message Service (SMS) 340. Each session may be related to a different interaction type, such as plan change, credit card, account info, bill pay and the like.

According to some embodiments of the present disclosure, the calculation of the CSHAP score may take into consideration the total time of interaction on each of the channels. For example, for the chat 310 interaction the total time of interaction is 11 minutes, for the Facebook-chat 320 interaction the total time is 7 minutes, for the Whatsapp-messenger 330 interaction the total time is 9 minutes and for the SMS 340 interaction the total time is 6 minutes.

According to some embodiments of the present disclosure, furthermore, the focus time of each interaction FTi in formula (1) when the agent was in an active conversation with the customer may be taken into consideration.

According to some embodiments of the present disclosure, customer feedback score CSi for each of these interactions may be taken into consideration as shown in formula (I):

$$Concurrent Sessions Handling Agent Proficiency ( CSHAP ) score = {\sum }_{i = 1}^{N} ( \frac{CSi + FTi}{T i} ) * W effective \qquad ( 1 )$$

whereby:

N is a total number of concurrent different interactions handled by an agent during the preconfigured period,

CSi is Customer Sentiment or feedback score for an interaction,

Ti is total time taken to handle an interaction, and

FTi is total time of one or more focused events during an interaction W_{effective} is an effective weighting factor of concurrent channel requests based on formula II:

Πᵢ₌₁^{N}Wi (II)

whereby:

Wi is a weighting factor of each channel type, and N is a total number of concurrent different interactions handled by an agent during the preconfigured period.

According to some embodiments of the present disclosure, the graphic representation 300 shows a high amount of focused time during the four concurrent sessions which with high customer sentiment score (CSi) may signify that the agent is able to focus on multiple channel along with efficiently handling the customer. The CSHAP score may also denote the agent's productivity and utilization rate of channels being used.

FIG. 4 schematically illustrates components of an example 400 of a CSHAP module determining agent proficiency when addressing concurrent customer sessions via one or more channel types by considering inactive-time of an agent and a customer during an interaction and utilization thereof by a gamification application, in accordance with some embodiments of the present disclosure.

Gamification solutions are commonly used to motivate agents and to improve their performance and rank by providing challenges, activities, quests, campaigns and tasks. These levels and activities are designed to boost the agents' performance by allowing them to “level-up”.

According to some embodiments of the present disclosure, a user, may predefine a Concurrent Sessions Handling Agent Proficiency (CSHAP) threshold and may set goals. The metrics for the goals, such as metrics 410, may be saved in a gamification module 420. Based on a calculated CSHAP score, which may be calculated by a module, such as CSHAP module 440 and such as CSHAP module 135 in FIGS. 1A-1B, some rewards and recognition may be provided to agents 430.

For example, a preconfigured threshold may be an CSHAP score above ‘0.8’ as in element 410a, which may assign the agent a recognition of golden badge and a reward of $200. The threshold may be a CSHAP score between a predefined range, such as ‘0.7’5<=CSHAP score <‘0.8’ as shown in element 410b, which may assign the agent with a silver badge and a reward of $100. Such a metric 410 may be created and saved inside the gamification application and may set goals to be saved in a gamification module 420.

According to some embodiments of the present disclosure, in a team such as team 430 for each agent a CSHAP score may be calculated for addressing concurrent customer sessions via one or more channel types by CSHAP module 440, and such as CSHAP module 135 in FIGS. 1A-1B. The calculated CSHAP score may be sent to a gamification module 420, which has already been provided with a metric of CSHAP threshold recognition and reward, such as metric 410.

According to some embodiments of the present disclosure, the calculated CSHAP score of each agent in the team 430, may be compared with the threshold in a predefined metric, such as metric 410, e.g., actual CSHAP score>=CSHAP threshold. When the calculated CSHAP score of one or more agents complies with the conditions in metric 410, and the agent is eligible for reward and recognition 450, then the gaming application may take a follow-up action such as send a notification to agents 460.

According to some embodiments of the present disclosure, for example, when the calculated CSHAP score of an agent may be above ‘0.8’, according to metric 410, the agent may receive a notification as to golden badge 460a.

According to some embodiments of the present disclosure, in another example, when the calculated CSHAP score of an agent may be between the range of ‘0.75’ and ‘0.8’, e.g., ‘0.75’<=CSHAP score<‘0.8’, according to metric 410, the agent may receive a as to a silver badge 460b.

FIG. 5 schematically illustrates components of an example 500 of a CSHAP module determining agent proficiency when addressing concurrent customer sessions via one or more channel types by considering inactive-time of an agent and a customer during an interaction and utilization thereof by a Quality Management (QM) application, in accordance with some embodiments of the present disclosure.

According to some embodiments of the present disclosure, each agent of agents 510 may be calculated a CSHAP score by a module such as CSHAP module 520 and such as module CSHAP 135 in FIGS. 1A-1B.

According to some embodiments of the present disclosure, a threshold may be provided by QM application 540 to check if the agent CSHAP score is below a threshold 530. When the CSHAP score is below the threshold the agent may need a coaching package assignment 550 which may be assigned out of existing packages by a user, such as a manager, e.g. coaching packages 560a-560c.

It should be understood with respect to any flowchart referenced herein that the division of the illustrated method into discrete operations represented by blocks of the flowchart has been selected for convenience and clarity only. Alternative division of the illustrated method into discrete operations is possible with equivalent results. Such alternative division of the illustrated method into discrete operations should be understood as representing other embodiments of the illustrated method.

Similarly, it should be understood that, unless indicated otherwise, the illustrated order of execution of the operations represented by blocks of any flowchart referenced herein has been selected for convenience and clarity only. Operations of the illustrated method may be executed in an alternative order, or concurrently, with equivalent results. Such reordering of operations of the illustrated method should be understood as representing other embodiments of the illustrated method.

Different embodiments are disclosed herein. Features of certain embodiments may be combined with features of other embodiments; thus, certain embodiments may be combinations of features of multiple embodiments. The foregoing description of the embodiments of the disclosure has been presented for the purposes of illustration and description. It is not intended to be exhaustive or to limit the disclosure to the precise form disclosed. It should be appreciated by persons skilled in the art that many modifications, variations, substitutions, changes, and equivalents are possible in light of the above teaching. It is, therefore, to be understood that the appended claims are intended to cover all such modifications and changes as fall within the true spirit of the disclosure.

While certain features of the disclosure have been illustrated and described herein, many modifications, substitutions, changes, and equivalents will now occur to those of ordinary skill in the art. It is, therefore, to be understood that the appended claims are intended to cover all such modifications and changes as fall within the true spirit of the disclosure.

What is claimed:

1. A computerized-method for determining an agent proficiency when addressing concurrent customer sessions via one or more channel types and utilization thereof, the computerized-method comprising:
in a computerized system comprising one or more processors, a data store of interactions, a data store of agents; and a memory to store the data stores, said one or more processors are operating for each agent in the data store of agents, a Concurrent Sessions Handling Agent Proficiency (CSHAP) module said CSHAP module comprising:
(a) operating an interactions module to retrieve one or more interactions and metadata thereof of the agent during a preconfigured period from the data store of interactions;
(b) for each interaction of the one or more retrieved interactions, determining if the interaction has been handled with concurrent different interactions during the preconfigured period via one or more channel types;
(c) for each determined interaction as handled with concurrent different interactions, checking in the metadata if the interaction has one or more defocused events, wherein defocused events are inactive-time events of an agent and a customer during the interaction and focused events are active-time events of the agent and the customer;
(d) calculating a CSHAP score for the agent based on one or more attributes from the metadata of the interaction to provide an indication as to an ability of the agent to address different concurrent customer sessions via one or more channel types;
(e) storing the calculated CSHAP score in the data store of agents; and
(f) sending the CSHAP score to one or more applications, to take one or more follow-up actions based on the CSHAP score.

2. The computerized-method of claim 1, wherein the CSHAP module is operating every preconfigured duty cycle.

3. The computerized-method of claim 1, wherein the calculating of the CSHAP score for the agent is based on formula (1):
$$Concurrent Sessions Handling Agent Proficiency ( CSHAP ) score = {\sum }_{i = 1}^{N} ( \frac{CSi + FTi}{T i} ) * W effective \qquad ( 1 )$$
whereby:
N is a total number of concurrent different interactions handled by an agent during the preconfigured period,
CSi is Customer Sentiment or feedback score for an interaction,
Ti is total time taken to handle an interaction,
FTi is total time of one or more focused events during an interaction
W_{effective} is an effective weighting factor of concurrent channel requests based on formula II:
Πᵢ₌₁^{N}Wi (II)
whereby:
Wi is a weighting factor of each channel type, and
N is a total number of concurrent different interactions handled by an agent during the preconfigured period.

4. The computerized-method of claim 1, wherein one application of the one or more applications is a gamification application.

5. The computerized-method of claim 4, wherein the one or more follow-up actions of the gamification application based on the CSHAP score, is providing at least one reward or recognition to the agent.

6. The computerized-method of claim 5, wherein the at least one reward or recognition to the agent is provided to the agent, when the CSHAP score is above a predefined threshold or between a predefined range.

7. The computerized-method of claim 1, wherein one application of the one or more applications is a Quality Management (QM) application.

8. The computerized-method of claim 7, wherein the one or more follow-up actions of the QM application based on the CSHAP score is assigning a coaching program by an evaluator when the CSHAP score is below a predefined threshold.

9. The computerized-method of claim 1, wherein one application of the one or more applications is an Automated Call Distribution (ACD) system.

10. The computerized-method of claim 9, wherein the one or more follow-up actions of the ACD system based on the CSHAP score includes changing attributes of routing skills of the agent.

11. The computerized-method of claim 1, wherein when the computerized-method is operating in a cloud computing environment, before operating the CSHAP module the computerized-method is further comprising selecting a tenant from a data store of tenants to operate the CSHAP module for each agent in the data store of agents of the selected tenant.

12. A computerized-system for determining an agent proficiency when addressing concurrent customer sessions via one or more channel types and utilization thereof, the computerized-system comprising:
one or more processors;
a data store of interactions;
a data store of agents; and a memory to store the data stores,
said one or more processors are configured to operate for each agent in the data store of agents, a Concurrent Sessions Handling Agent Proficiency (CSHAP) module said CSHAP module comprising:
(a) operating an interactions module to retrieve one or more interactions and metadata thereof of the agent during a preconfigured period from the data store of interactions;
(b) for each interaction of the one or more retrieved interactions, determining if the interaction has been handled with concurrent different interactions during the preconfigured period via one or more channel types;
(c) for each determined interaction as handled with concurrent different interactions, checking in the metadata if the interaction has one or more defocused events, wherein defocused events are inactive-time events of an agent and a customer during the interaction and focused events are active-time events of the agent and the customer;
(d) calculating a CSHAP score for the agent based on one or more attributes from the metadata of the interaction to provide an indication as to an ability of the agent to address different concurrent customer sessions via one or more channel types;
(e) storing the calculated CSHAP score in the data store of agents; and
(f) sending the CSHAP score to one or more applications, to take one or more follow-up actions based on the CSHAP score.
